(19) United States
(12) Patent Application Publication
(10) Pub. No.: US 2004/0195871 A1
(43) Pub. Date: Oct. 7, 2004

(54) Method for making a bicycle seat and product made thereby

(75) Inventor: Ching-Song Lee, Nan-Tou City (TW)

Correspondence Address: Ladas & Parry, Suite #2100, 5670 Wilshire Boulevard, Los Angeles, CA, 90036-5679, US

(73) Assignee: CIONLLI INDUSTRIAL CO., LTD.

(21) Appl. No.: 10/406,062

(22) Filed: Apr. 2, 2003

(51) Int. Cl. B62J 1/18

(52) U.S. Cl. 297/214

(57) ABSTRACT

A method for making a bicycle seat includes the steps of: preparing a seat base made of a rigid plastic material; forming a foamed seat body from EVA copolymer; and installing the foamed seat body on the seat base. The seat base includes a top face, a bottom face, and a peripheral edge interconnecting peripheral ends of the top and bottom faces. The foamed seat body includes a seat portion having a bottom face corresponding to the top face of the seat base and a top face opposite to the bottom face of the seat portion of the seat body, and a lip portion extending around the seat portion of the seat body. The lip portion of the seat body embraces the peripheral edge of the seat base after installing the foamed seat body on the seat base.

### BACKGROUND OF THE INVENTION

1. Field of the Invention

The invention relates to a method for making a bicycle seat and the product made thereby, more particularly to a method for making a bicycle seat, which will not produce toxic material during production or upon disposal of the bicycle seat, and which is friendly to the environment.

2. Description of the Related Art

A conventional bicycle seat generally includes a seat base, a foam mounted on the seat base, and an outer cover for covering the foam. The outer cover is primarily made of polyvinyl chloride, which will decompose to release toxic material (such as dioxin and the like) during production or upon disposal. The foam is usually made of polyurethane together with solvents such as toluene and the like. However, these solvents are harmful to the environment.

Furthermore, the foam may be formed with a relief pattern at the top face thereof in order to enhance the aesthetic appearance of the bicycle seat. However, the relief pattern will not be apparent since the foam is covered by the outer cover. Additionally, the outer cover is liable to absorb and collect heat due to exposure to sunlight, which will make the rider feel uncomfortable.

### SUMMARY OF THE INVENTION

Therefore, the object of the present invention is to provide a method for making a bicycle seat and a product made thereby to overcome the aforesaid shortcomings of the prior art.

According to one aspect of this invention, a method for making a bicycle seat includes the steps of: preparing a seat base made of a rigid plastic material; forming a foamed seat body from ethylene-vinyl acetate copolymer (EVA copolymer); and installing the foamed seat body on the seat base.

In another aspect of this invention, a bicycle seat includes a seat base made of a rigid plastic material, and a foamed seat body made by molding EVA copolymer. The seat base includes a top face having a peripheral end, a bottom face opposite to the top face and having a peripheral end, and a peripheral edge interconnecting the peripheral ends of the top and bottom faces. The foamed seat body includes a seat portion having a bottom face corresponding to the top face of the seat base and a top face opposite to the bottom face of the seat portion of the seat body, and a lip portion extending around the seat portion of the seat body. The lip portion of the seat body embraces the peripheral edge of the seat base after installing the foamed seat body on the seat base.

### BRIEF DESCRIPTION OF THE DRAWINGS

Other features and advantages of the present invention will become apparent in the following detailed description of the preferred embodiment with reference to the accompanying drawings, of which:

FIG. 1 is a flow chart illustrating consecutive steps of a preferred embodiment of a method for making a bicycle seat according to this invention;

FIG. 2 is an exploded perspective view of the bicycle seat made according to the preferred embodiment; and

FIG. 3 is a sectional view of the bicycle seat.

### DETAILED DESCRIPTION OF THE PREFERRED EMBODIMENTS

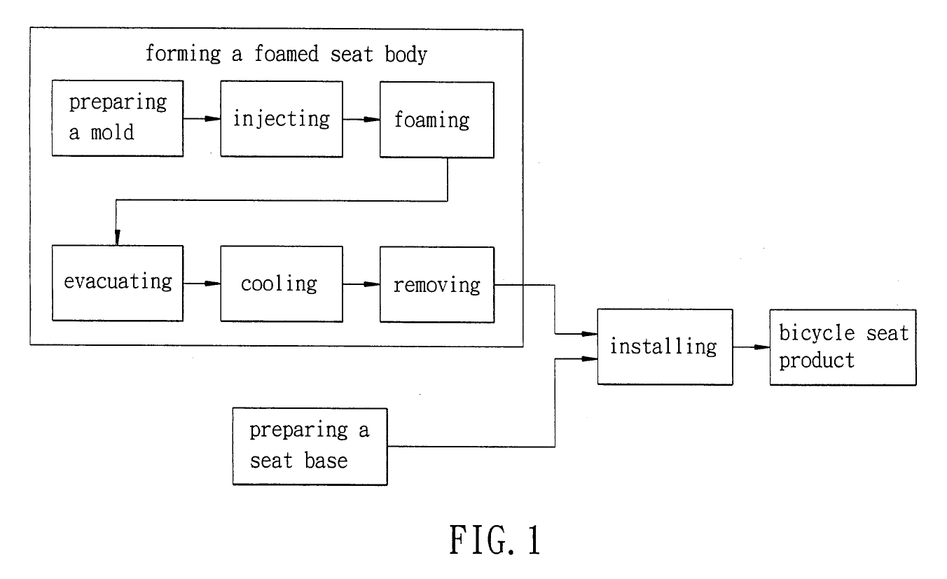

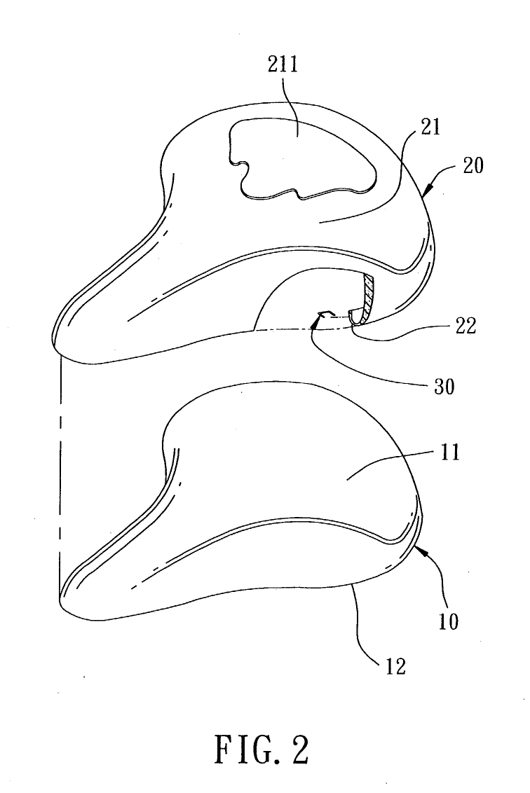

Referring to FIGS. 1, 2 and 3, the preferred embodiment of the method for making a bicycle seat according to this invention includes the steps of:

A) preparing a seat base 10:

The seat base 10 is made of a rigid plastic material, and includes a top face 11 having a peripheral end 111, a bottom face 12 opposite to the top face 11 and having a peripheral end 121, and a peripheral edge 13 interconnecting the peripheral ends 111, 121 of the top and bottom faces 11, 12.

B) forming a foamed seat body 20:

The foamed seat body 20 is formed from EVA copolymer by the following sub-steps:

B1) preparing a mold:

A mold having a cavity is prepared.

B2) injecting:

A melt of the EVA copolymer is injected into the cavity of the mold.

B3) foaming:

The melt is foamed in the cavity of the mold.

B4) evacuating:

The cavity of the mold is evacuated so as to expand the melt, and so as to form the foamed seat body 20.

B5) cooling:

The foamed seat body 20 is cooled.

B6) removing:

The foamed seat body 20 is removed from the cavity of the mold.

The seat body 20 made in this step includes a seat portion 21 having a bottom face 230 corresponding to the top face 11 of the seat base 10 and a top face 210 opposite to the bottom face 230 of the seat portion 21 of the seat body 20, and a lip portion 22 extending around the seat portion 21 of the seat body 20.

C) installing the foamed seat body 20 on the seat base 10:

The foamed seat body 20 is installed on the seat base 10 such that the lip portion 22 of the seat body 20 embraces the peripheral edge 13 of the seat base 10. The lip portion 22 of the seat body 20 is then fixed on the peripheral edge 13 of the seat base 10 using nails 30 so as to complete the bicycle seat product.

Preferably, the top portion of the cavity of the mold is provided with a relief profile so that the foamed seat body 20 is integrally formed with a relief pattern 211 during the step of forming the foamed seat body 20.

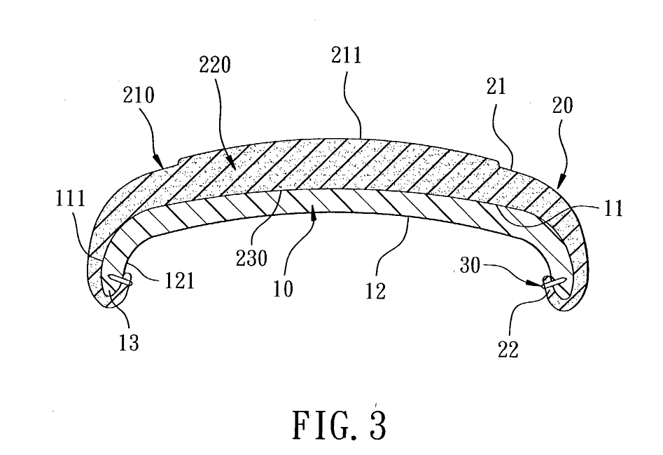

Referring again to FIG. 3, in contrast to the seat body of the prior art which is composed of the outer cover and the foam that are separately produced, the seat body 20 is integrally formed of water-proof EVA copolymer. Therefore, the seat body 20 made by the preferred embodiment of the present method includes a water-proof top surface 210 and an inner foam 220 which are connected integrally.

Therefore, the bicycle seat of this invention has the following advantages:

1. The seat body 20 made of EVA copolymer does not release toxic material during processing or upon disposal. The solvents used in the prior art are not required in the method of the present invention. The pollution problems resulting from the use of such solvents are accordingly avoided.

2. The top surface 210 and the inner foam 220 are integrally formed into the seat body 210 in a single molding step, which in turn enhances productivity and lowers production costs.

3. The inner foam 220 of the seat body 20 has a plurality of cells, which can reduce the uncomfortable feeling due to heat absorption commonly experienced in the prior art.

4. The relief pattern 211 is integrally formed at the top surface 210 of the seat body 20. Accordingly, the aesthetic appearance of the bicycle seat is relatively improved.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method for making a bicycle seat, comprising the steps of:
preparing a seat base made of a rigid plastic material;
forming a foamed seat body from ethylene-vinyl acetate copolymer; and
installing said foamed seat body on said seat base.

2. The method as claimed in claim 1, wherein said foamed seat body is formed with a relief pattern during said step of forming said foamed seat body.

3. The method as claimed in claim 1, wherein said step of forming said foamed seat body includes the sub-steps of:
preparing a mold having a cavity;
injecting a melt of said ethylene-vinyl acetate copolymer into said cavity of said mold;
foaming said melt in said cavity of said mold;
evacuating said cavity of said mold so as to expand said melt, and so as to form said foamed seat body;
cooling said foamed seat body; and
removing said foamed seat body from said cavity of said mold.

4. The method as claimed in claim 1, wherein said seat base includes a top face having a peripheral end, a bottom face opposite to said top face and having a peripheral end, and a peripheral edge interconnecting said peripheral ends of said top and bottom faces, said seat body including a seat portion having a bottom face corresponding to said top face of said seat base and a top face opposite to said bottom face of said seat portion of said seat body, and a lip portion extending around said seat portion of said seat body, said lip portion of said seat body embracing said peripheral edge of said seat base after installing said foamed seat body on said seat base.

5. The method as claimed in claim 4, further comprising a step of fixing said lip portion of said seat body on said peripheral edge of said seat base.

6. The method as claimed in claim 5, wherein said step of fixing is conducted by nailing.

7. A bicycle seat, comprising:
a seat base made of a rigid plastic material, said seat base including a top face having a peripheral end, a bottom face opposite to said top face and having a peripheral end, and a peripheral edge interconnecting said peripheral ends of said top and bottom faces; and
a foamed seat body made by molding ethylene-vinyl acetate copolymer, said foamed seat body including a seat portion having a bottom face corresponding to said top face of said seat base and a top face opposite to said bottom face of said seat portion of said seat body, and a lip portion extending around said seat portion of said seat body, said lip portion of said seat body embracing said peripheral edge of said seat base after installing said foamed seat body on said seat base.

8. The bicycle seat as claimed in claim 7, further comprising a fixing member for fixing said lip portion of said seat body on said peripheral edge of said seat base.

9. The bicycle seat as claimed in claim 8, wherein said fixing member is a nail.

10. The bicycle seat as claimed in claim 7, wherein said seat portion of said seat body is thicker than said lip portion of said seat body.

11. The bicycle seat as claimed in claim 7, wherein said seat portion of said seat body is integrally formed with a relief pattern at said top face thereof.
